(19) United States
(12) Patent Application Publication
(10) Pub. No.: US 2025/0251875 A1
(43) Pub. Date: Aug. 7, 2025

(54) SIMULATING DRIVE VERIFICATION TESTING

(71) Applicant: International Business Machines Corporation, Armonk, NY (US)

(72) Inventors: Tom Liebsch, Arlington, SD (US); Brent William Yardley, Hillsboro, OR (US); Kunjan Dedhia, Richmond, TX (US)

(21) Appl. No.: 18/431,776

(22) Filed: Feb. 2, 2024

(51) Int. Cl. G06F 3/06

(52) U.S. Cl. CPC G06F 3/0653; G06F 3/0604; G06F 3/0673

(57) ABSTRACT

A computer-implemented method (CIM) according to one approach, includes causing a power load in a data storage simulation device to draw a first amount of power and release a first amount of thermal energy, in response to the data storage simulation device being inserted into a drive slot. Temperature information is received from one or more temperature sensors in the data storage simulation device. Power information is also received from one or more current sensors in the data storage simulation device, and movement information is received from one or more accelerometers in the data storage simulation device. The received temperature information, power information, and movement information is further used to determine whether performance of the data storage simulation device is inside a predetermined range.

### BACKGROUND

The present invention relates to drive enclosure testing, and more specifically, this invention relates to performing verification testing on drive enclosures.

Data storage systems are often tested in a number of different operating conditions before being released for use by customers. For instance, the design process of storage systems having drives, e.g., such as hard disk drives (HDDs), involves testing the drives in a number of different functional use cases that produce different operating conditions. These use cases that are tested represent different thermal characteristics, power consumption profiles, highspeed signal processing and integrity procedures, etc., that a drive enclosure may experience.

Conventional testing painstakingly replicates each of these use cases by combining a specific arrangement of supported drive types in an enclosure and tailoring drive performance. This often leads to pushing the drive designs to their limits and even beyond. Accordingly, there exists a desire to improve the efficiency by which drive enclosures are tested for various use cases.

### SUMMARY

A computer-implemented method (CIM) according to one approach, includes causing a power load in a data storage simulation device to draw a first amount of power and release a first amount of thermal energy, in response to the data storage simulation device being inserted into a drive slot. Temperature information is received from one or more temperature sensors in the data storage simulation device. Power information is also received from one or more current sensors in the data storage simulation device, and movement information is received from one or more accelerometers in the data storage simulation device. The received temperature information, power information, and movement information is further used to determine whether performance of the data storage simulation device is inside a predetermined range.

A computer program product (CPP), according to another approach, includes: a set of one or more computer-readable storage media, and program instructions. The program instructions are collectively stored in the set of one or more storage media. Moreover, the program instructions are for causing a processor set to perform the foregoing CIM, in response to a data storage simulation device being inserted into a drive slot.

A computer system (CS), according to yet another approach, includes: a processor set, and a set of one or more computer-readable storage media. The CS also includes program instructions that are collectively stored in the set of one or more storage media. The program instructions are for causing the processor set to perform the foregoing CIM in response to a data storage simulation device being inserted into a drive slot.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a diagram of a tiered data storage system, in accordance with one approach.

FIG. 2B is a representational view of a distributed system, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for performing more efficient verification testing procedures that consume much fewer resources than conventional procedures have been able to achieve. Approaches herein also introduce a significant amount of control to the testing environment, allowing for specific use cases to be easily simulated by reproducing the corresponding operating conditions. This control is achieved in some approaches by implementing design features that are configured to support the testing and validation of specific aspects. This allows for use cases that are often difficult or even impossible to replicate using standard drives, to be easily and repeatedly simulated such that testing may be performed, e.g., as will be described in further detail below.

In one general approach, a CIM includes causing a power load in a data storage simulation device to draw a first amount of power and release a first amount of thermal energy, in response to the data storage simulation device being inserted into a drive slot. Temperature information is received from one or more temperature sensors in the data storage simulation device. Power information is also received from one or more current sensors in the data storage simulation device, and movement information is received from one or more accelerometers in the data storage simulation device. The received temperature information, power information, and movement information is further used to determine whether performance of the data storage simulation device is inside a predetermined range.

In another general approach, a CPP includes: a set of one or more computer-readable storage media, and program instructions. The program instructions are collectively stored in the set of one or more storage media. Moreover, the program instructions are for causing a processor set to perform the foregoing CIM, in response to a data storage simulation device being inserted into a drive slot.

In yet another general approach, a CS includes: a processor set, and a set of one or more computer-readable storage media. The CS also includes program instructions that are collectively stored in the set of one or more storage media. The program instructions are for causing the processor set to perform the foregoing CIM in response to a data storage simulation device being inserted into a drive slot.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved verification testing code at block 150 for performing more efficient verification testing procedures that consume much fewer resources than conventional procedures have been able to achieve. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

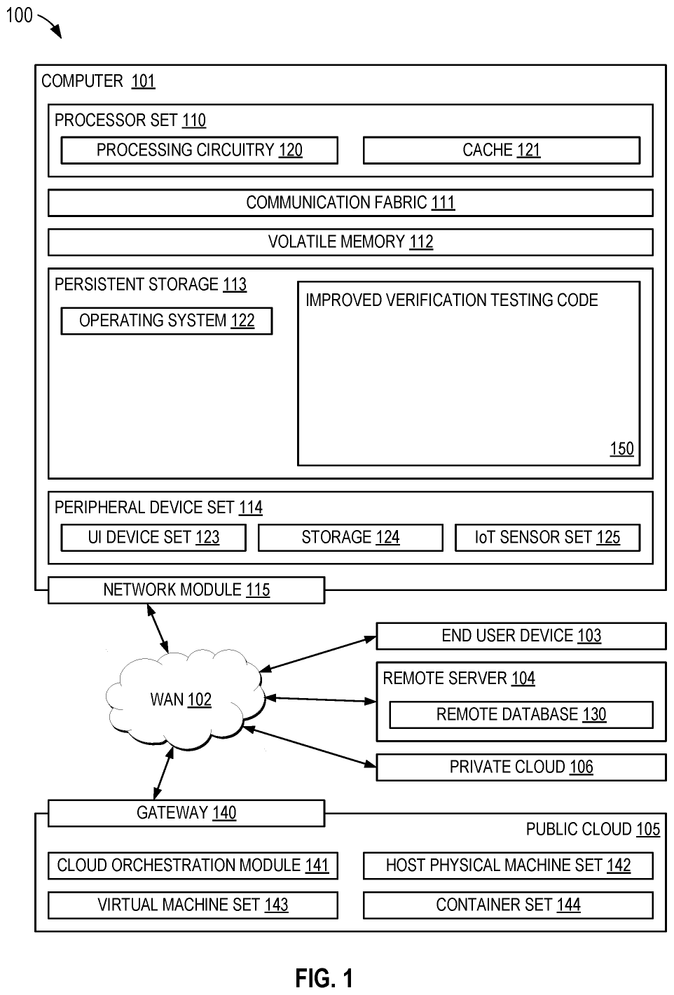

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

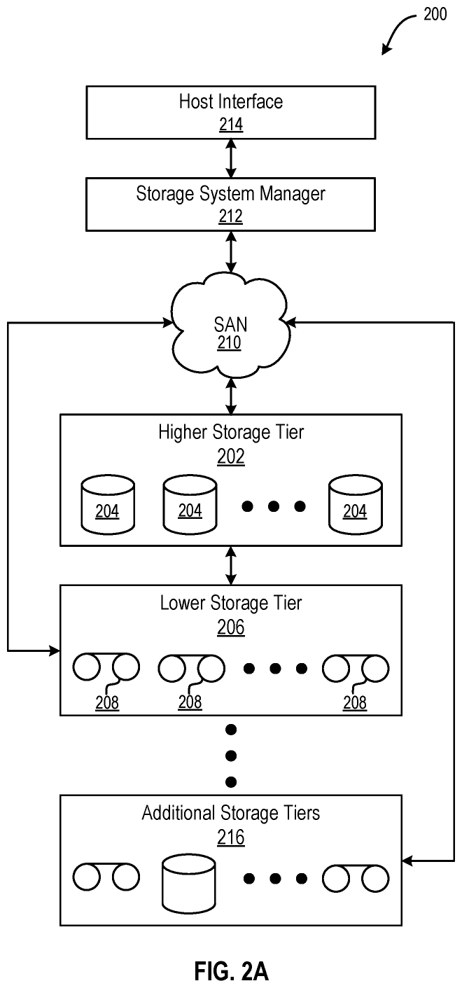

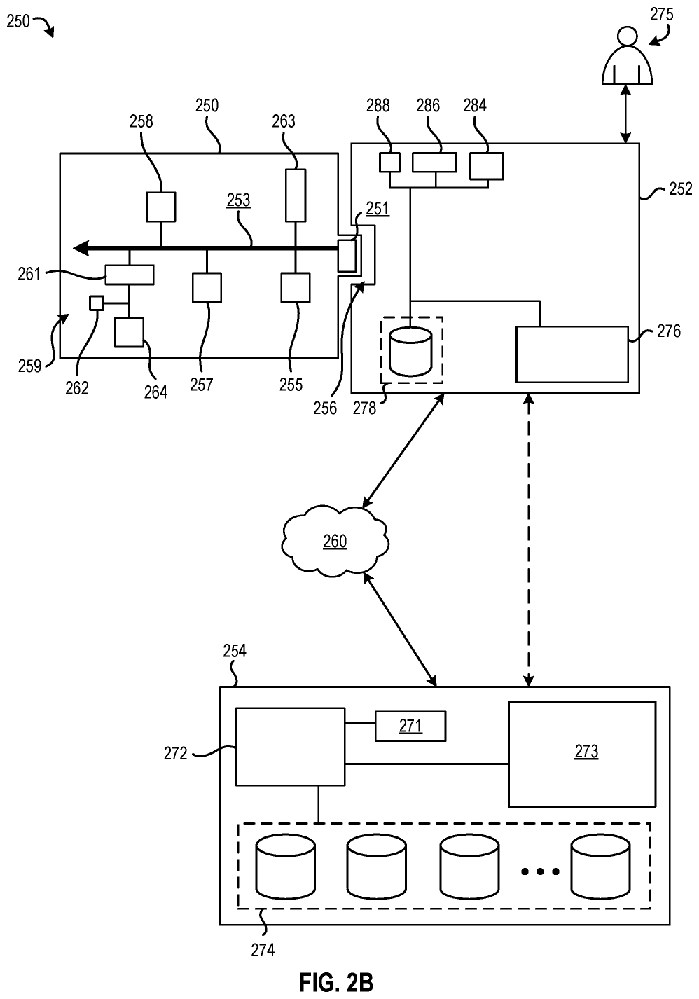

Now referring to FIG. 2A, a storage system 200 is shown according to one approach. Note that some of the elements shown in FIG. 2A may be implemented as hardware and/or software, according to various approaches. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in HDDs, nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2A, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the approaches presented herein.

According to some approaches, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As previously mentioned, the design process for storage systems that implement HDDs (e.g., see direct access media 204 of FIG. 2A) involves testing drive slots of an enclosure for a number of different functional use cases that produce different operating conditions. These use cases that are tested represent different thermal characteristics, power consumption profiles, highspeed signal processing and integrity procedures, etc., of a drive enclosure.

Conventional testing painstakingly replicates each of these use cases by combining a specific arrangement of supported drive types in an enclosure and tailoring drive performance. This often leads to pushing the drive designs to their limits and even beyond. Thus, while combinations of drives that validate a particular use case may be reused, invalidated use cases typically result in one or more of the drives underperforming, being damaged, or even rendered useless. Conventional testing has thereby suffered from significant inefficiencies that stem at least in part from how resource intensive the testing procedure is. Conventional testing is also a lengthy and restrictive process, not providing much control over how the testing is actually performed. Accordingly, there exists a desire to improve the efficiency by which HDD enclosures are tested for various use cases.

In sharp contrast, approaches herein introduce more efficient testing procedures that consume much fewer resources than conventional procedures have been able to achieve. Approaches herein also introduce a significant amount of control to the testing environment, allowing for specific use cases to be easily simulated by reproducing the corresponding operating conditions. This control is achieved in some approaches by implementing design features that are configured to support the testing and validation of specific aspects. This allows for use cases that are often difficult or even impossible to replicate using standard drives, to be easily and repeatedly simulated for testing.

For instance, approaches herein include data storage simulation devices that are able to simulate (e.g., mimic) any desired power loading. The data storage simulation devices may thereby provide dynamically settable and configurable power loads. This allows approaches herein to easily emulate different workloads of a device that may be installed in the enclosure slots of the data storage enclosure. The data storage simulation devices may also be able to simulate (e.g., mimic) any desired thermal equivalence. In other words, the data storage simulation devices may each be able to mimic the thermal dissipation of one or more physical components (e.g., HDDs) that may be installed in the enclosure slots of the respective data storage enclosure.

Approaches herein are thereby able to easily and efficiently provide a valid representation of (e.g., an analog for) thermal dissipation experienced by the data storage simulation devices. In some approaches, the data storage simulation devices are able to make shock and vibration measurements. The data storage simulation devices may thereby collect motion data that provides insight on relevant environmental conditions that are experienced, e.g., as will be described in further detail below.

It should also be noted that any of the approaches herein may perform testing on a data storage enclosure by using the data storage simulation device that emulates the design of an actual HDD enclosure. Thus, the data storage simulation device may be physically configured to have a same form factor as an HDD enclosure that is capable of including 1 HDD, 2 HDDs, 3 HDDs, 4 HDDs, 5 HDDs, 10 HDDs, 20 HDDs, etc. In other words, the data storage simulation device may be physically configured to receive one or more HDD components therein, connect to an external system using a specific physical connection port, be constructed from a same material as a typical HDD enclosure, etc. As noted above, this further improves operational efficiency, particularly compared to the shortcomings experienced by conventional testing procedures.

Looking now to FIG. 2B, a data storage simulation device 250 is shown coupled to (e.g., inserted in) a drive slot 256 in a data storage environment 252 of a host system 254, in accordance with one approach. As an option, the present configuration may be implemented in conjunction with features from any other approach listed herein, such as those described with reference to the other FIGS., e.g., such as FIG. 2A. For instance, the data storage simulation device 250 in FIG. 2B may be inserted in a drive of the direct access media 204 (e.g., HDDs) of storage system 200 in FIG. 2A to perform verification testing. However, the data storage simulation device 250 and others presented herein may be used in various applications and/or in permutations which may or may not be specifically described in the illustrative approaches or implementations listed herein. Further, the data storage simulation device 250 presented herein may be used in any desired environment, e.g., to conduct tailored verification testing. Thus FIG. 2B (and the other FIGS.) may be deemed to include any possible permutation.

As noted above, the data storage simulation device 250 is coupled to (e.g., inserted in) a drive slot 256 in a data storage environment 252 of a host system 254, in accordance with one approach. The host system 254 and data storage environment 252 are both connected to a network 260, and may thereby be positioned in different geographical locations. The network 260 may be of any type, e.g., depending on the desired approach. For instance, in some approaches the network 260 is a WAN, e.g., such as the Internet. However, an illustrative list of other network types which network 260 may implement includes, but is not limited to, a LAN, a PSTN, a SAN, an internal telephone network, etc. As a result, any desired information, data, commands, instructions, responses, requests, etc. may be sent between data storage environment 252 and host system 254, regardless of the amount of separation which exists therebetween, e.g., despite being positioned at different geographical locations. According to some approaches, the host system 254 is a remote cloud server that is connected to (e.g., may be accessed by) data storage environment 252.

However, data storage environment 252 and host system 254 may also be connected differently. The dashed line between data storage environment 252 and host system 254 is intended to indicate the two locations may be directly coupled to each other. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

Use of the term “user” herein is in no way intended to be limiting. For instance, while a user may be described as being an individual in approaches herein, a user may be an application, an organization, a preset process, etc. The use of the term “data,” “datasets,” and “information” herein are in no way intended to be limiting either, and may include any desired type of details, e.g., depending on the type of components included in the data storage simulation device 250, the operating system implemented at the data storage environment 252 and/or host system 254, etc.

In some approaches, sensor readings that are generated by components included in the data storage simulation device 250 may be transferred to the data storage environment 252 over a direct connection. Moreover, the sensor readings may be evaluated at the data storage environment 252 and/or the host system 254 to determine how the data storage simulation device 250 as a whole is performing. This provides valuable insight as to how an actual drive enclosure inserted in the drive slot 256 and coupled to the data storage environment 252 would function in a wide array of operating environments. For example, the amount of power supplied to the components in the data storage simulation device 250, the thermal properties experienced in the data storage simulation device 250, any vibration or movement experienced by the data storage simulation device 250, etc. may be captured by sensors positioned therein. Moreover, these sensor readings may be relayed to the data storage environment 252 and/or the host system 254 for evaluation, e.g., as will be described in further detail below.

Looking to the data storage simulation device 250, a connector 251 is configured to create a secure and functional connection with a drive slot 256 in the data storage environment 252. The drive slot 256 is thereby configured to receive the connector 251 and engage with the connection interface thereof. In other words, the drive slot 256 and connector 251 are preferably designed to create a mated connection therebetween, allowing for information, commands, instructions, responses, etc., to be exchanged between the data storage simulation device 250 and the data storage environment 252.

It should also be noted that the connector 251 and connection interface preferably have a form factor that approximates a connection interface at an exterior of an HDD or HDD enclosure. In other words, the connector 251 has a connection interface which replicates (e.g., copies) a connection interface on an HDD which is used to connect the HDD to a drive slot 256. The drive slot 256 is thereby also preferably designed to create a mated connection with the connection interface of an actual HDD or similar drive, allowing for information, commands, instructions, responses, etc., to be exchanged between the data storage environment 252 and the connected HDD. However, the data storage simulation device 250 itself does not include any functioning HDDs therein. As noted above, the data storage simulation device 250 is intended to replicate an enclosure that is configured to receive (e.g., hold) one or more HDDs therein. Thus, although the data storage simulation device 250 may include some similar characteristics with an actual HDD enclosure, e.g., such as a same or similar connection interface, a same or similar overall formfactor, constructed from a same or similar type of material(s), etc., the data storage simulation device 250 does not include any functioning HDDs or drives in general. The data storage enclosure verification testing may thereby be performed with the data storage simulation device 250 without actually damaging any functioning drives, thereby significantly lowering resource consumption, and expense. Moreover, these improvements are achieved while also producing a more accurate measurement of the environment, e.g., as would be appreciated by one skilled in the art after reading the present description.

Referring still to the data storage simulation device 250, the connector 251 is coupled to a control bus 253. As would be appreciated by one skilled in the art, the control bus 253 enables information, commands, instructions, responses, etc., that are received from the data storage environment 252 through the connector 251 to be delivered to a number of components in the data storage simulation device 250 that are connected to the control bus 253. It follows that the control bus 253 may include any desired type of communication bus.

As noted above, a number of sensors may be included in the data storage simulation device 250 to collect readings that provide insight on performance of the data storage simulation device 250. For instance, the control bus 253 is connected to a temperature sensor 255, a current sensor 257, and an accelerometer 258. The control bus 253 is thereby able to deliver signals (e.g., instructions) that cause the temperature sensor 255, current sensor 257, and/or accelerometer 258 to collect readings from the data storage simulation device 250. The accelerometer 258 is preferably configured to measure the vibration, or acceleration of motion, of a structure that it is attached to.

The control bus 253 is also able to return the readings that are taken to the data storage environment 252 through the connector 251. The data storage simulation device 250 is thereby able to return sensor readings and other information that provides insight as to how the device 250 and the components therein performed in a number of different operating conditions that are correlated with different use cases. For example, the power supplied to, power consumed by, thermal operating conditions of, etc., the data storage simulation device 250 may be adjusted according to verification testing that may be performed. As noted above, drive components (e.g., HDD enclosures) are preferably tested in a range of situations as a part of verification testing to ensure the components are able to operate successfully in those situations. The information (e.g., readings) collected by the temperature sensor 255, current sensor 257, and/or accelerometer 258 may thereby be used by the data storage environment 252 to determine whether each segment of a verification testing procedure is satisfied.

The data storage simulation device 250 also includes a power control module 259 having a resistor load bank 264 and a general purpose input/output (GPIO) expander 261 connected by a dual inline package (DIP) switch 262. This combination of components allows the power control module 259 to draw a desired amount of power and release (e.g., produce) a desired amount of thermal energy. This may be achieved by running a specific (e.g., calculated) amount of current through the resistor load bank 264 as controlled at least in part by the DIP switch 262. The amount of current may be controlled by the signals (e.g., control commands) received across the connector 251 and transmitted along the control bus 253 to the power control module 259, e.g., as would be appreciated by one skilled in the art after reading the present description.

The data storage simulation device 250 further includes a secondary connector 263. The secondary connector 263 may provide a direct access point that allows for communication and/or control to be established with the data storage simulation device 250. In some approaches the secondary connector 263 may be a physical connection port that is configured to provide access in response to a physical connection being made with a corresponding port. In some approaches, the secondary connector 263 is a logical connection port that provides remote access to the data storage simulation device 250 and the components therein. Control of the components in the data storage simulation device 250 may thereby be obtained in some situations by establishing a wireless connection to the secondary connector 263.

It should be noted that the number and/or type of components illustrated in FIG. 2B as being part of the data storage simulation device 250 are in no way intended to be limiting. As noted above, the data storage simulation device 250 is simulating a number of different scenarios to perform verification testing. Thus, the data storage simulation device 250 may be configured to include any desired number, type, configuration, etc. of components therein. For example, in some situations the data storage simulation device 250 may be replicating an HDD enclosure that accommodates a single drive, while in other situations the data storage simulation device 250 is replicating an HDD enclosure that accommodates two or more drives. It follows that dimensions of the data storage simulation device 250 may be adjusted depending on the approach.

With continued reference to FIG. 2A, the host system 254 includes a large (e.g., robust) processor 272 coupled to a cache 271, an AI module 273, and a data storage array 274 having a relatively high storage capacity. The AI module 273 may include any desired number and/or type of AI-based models, e.g., such as machine learning models, deep learning models, neural networks, etc. In some approaches, one or more of the models in the AI module 273 may be trained using one or more types of sensor readings that are received from a data storage simulation device 250 inserted in the drive slot 256 of data storage environment 252. It follows that sensor reading and other information received as a result of performing verification testing on the data storage simulation device 250 may be sent to the AI module 273 to train or retrain one or more models maintained therein. These models may be configured to output a predicted performance profile in response to receiving sensor data from the data storage simulation device 250 from verification testing. Moreover, the predicted performance profile may be converted into different formats and transmitted to other remote locations over network 260.

Data storage environment 252 includes a processor 276 which is coupled to memory 278. The processor 276 receives inputs from user 275 as well as the data storage simulation device 250 inserted in the drive slot 256. For instance, the user 275 may input information using one or more of: a display screen 284, keys of a computer keyboard 286, and a computer mouse 288. The processor 276 may thereby be configured to receive inputs (e.g., text, sounds, images, motion data, etc.) from any of these components as entered by the user 275. These inputs typically correspond to information presented on the display screen 284 while the entries were received. Moreover, the inputs received from the keyboard 286 and computer mouse 288 may impact the information shown on display screen 284, data stored in memory 278, information collected from the data storage simulation device 250, status of an operating system being implemented by processor 276, etc.

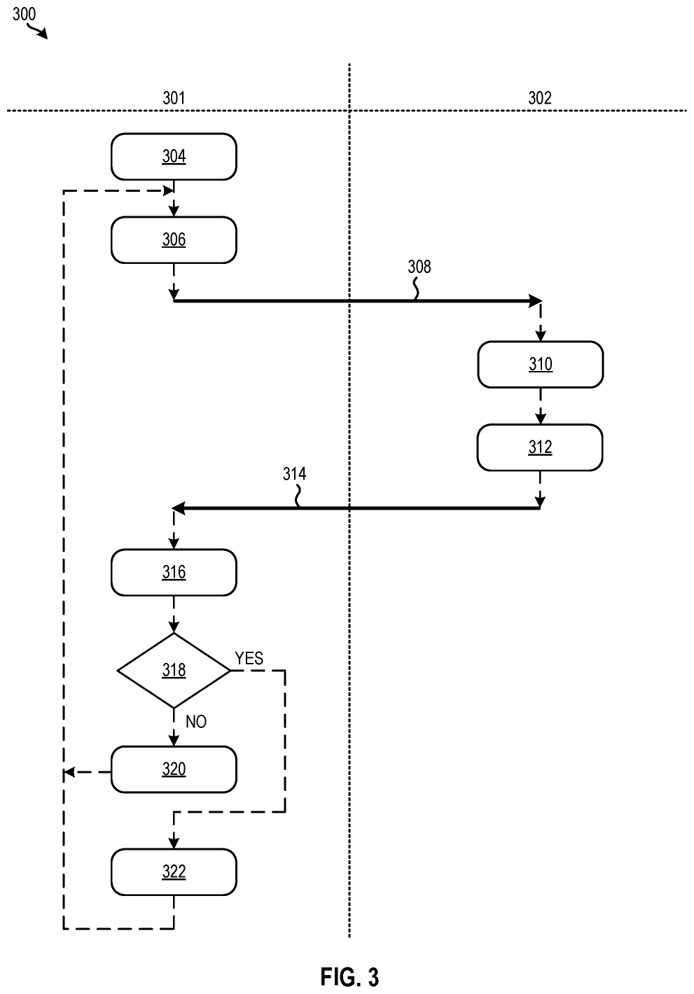

Looking now to FIG. 3, a computer-implemented method 300 for performing verification testing of an HDD enclosure using a data storage simulation device is illustrated in accordance with one approach. One or more of the operations in method 300 may thereby be used to control the operating settings implemented in a simulation device to perform verification testing, e.g., as described above.

While certain information (e.g., warnings, reports, read requests, etc.) may be issued to a user, it is again noted that the various operations of method 300 can be repeated in an iterative fashion for each set of environmental conditions of a verification testing procedure. Thus, method 300 may be performed in accordance with the present invention in any of the environments depicted in FIGS. 1-2B, among others, in various approaches. Of course, more or less operations than those specifically described in FIG. 3 may be included in method 300, as would be understood by one of skill in the art upon reading the present descriptions.

Each of the steps of the method 300 may be performed by any suitable component of the operating environment. For example, both of the nodes 301, 302 shown in the flowchart of method 300 may correspond to components positioned at different locations. Moreover, components at each of the nodes 301, 302 are preferably configured to communicate with each other. For instance, node 301 may include one or more processors located at a data processing location of a system (e.g., see data storage environment 252 and host system 254 of FIG. 2A above). Moreover, node 302 may include components of a data storage simulation device that is connected to (e.g., inserted in a port of) the data processing location of node 301 (e.g., see data storage simulation device 250 of FIG. 2A above). It follows that the interface between nodes 301 and 302 may represent the interface between connector 251 and drive slot 256 as seen in FIG. 2B. Accordingly, commands, data, requests, etc. may be sent between the nodes 301, 302.

It should also be noted that the various operations included in method 300 are in no way intended to be limiting, e.g., as would be appreciated by one skilled in the art after reading the present description. For instance, data sent from node 302 to node 301 may be prefaced by a request sent from node 301 to node 302 in some approaches. Additionally, the number of nodes included in FIG. 3 is in no way intended to be limiting. For instance, additional data storage simulation devices may be coupled to node 301 for overlapping verification testing in some approaches. Accordingly, any desired number of data storage simulation devices may be connected to a central testing hub, e.g., as would be appreciated by one skilled in the art after reading the present description.

As shown in the flowchart, method 300 includes operation 304 which is performed at node 301. There, operation 304 includes a data storage simulation device being inserted into a drive slot. Operation 304 may thereby be initiated in response to determining that a data storage simulation device has been inserted into the drive slot. In some approaches, method 300 involves scanning for any connection signals received from one or more connection interfaces.

From operation 304, method 300 proceeds to operation 306. There, operation 306 includes determining a verification testing procedure that should be applied to the data storage simulation device that has been inserted in the drive slot. In some approaches, the simulation device may provide information that outlines a desired verification testing procedure to apply. In other approaches, information outlining a verification testing procedure to apply to the inserted data storage simulation device may be obtained by accessing one or more lookup tables, in response to querying a running verification testing application, from a user, etc.

As previously noted, a verification testing procedure may outline any desired number of operating conditions (e.g., operating environments) that a given data storage simulation device should be subjected to in order to determine performance. Thus, in response to determining the verification testing procedure to apply to the data storage simulation device, method 300 advances to operation 308. There, operation 308 includes sending one or more instructions to node 302 that cause a first set of operating conditions from the verification testing procedure to be implemented. In some approaches, the first set of operating conditions specifies a first power draw and a first amount of thermal energy released. Additional signals may also be sent with the instructions that are delivered to node 302 from 301. For instance, electrical power, electrical ground, Inter-Integrated Circuit (I2C) signals, etc. associated with implementing the one or more instructions may also be sent from a host system at node 301 to the data storage simulation device at node 302 through a link formed between the connection interface of the data storage simulation device at node 302 and the drive slot of the host system at node 301. Additional signals including storage communication signals, sideband signals, control bus signals, etc., or any other signals associated with implementing the present operating conditions may also be sent from node 301 to node 302, e.g., as would be appreciated by one skilled in the art after reading the present description.

In response to receiving the one or more instructions at node 302 and other signals, operation 310 involves satisfying (e.g., implementing) the one or more instructions by adjusting various operating settings of the components in the data storage simulation device at node 302. According to one example, the one or more instructions sent in operation 308 cause a power load in the data storage simulation device at node 302 to draw a specific amount of power and release (e.g., produce) a specific amount of thermal energy. In some approaches, the specific amount of power may be drawn from a dynamic power supply provided to the data storage simulation device over the connection between nodes 301 and 302.

Again, the first set of operating conditions are correlated with a particular segment of a verification testing procedure. Thus, information explaining how the data storage simulation device and the components therein performed in the first set of operating conditions is preferably captured and returned for evaluation. Operation 312 thereby includes collecting sensor readings (e.g., data) from one or more sensors that are included in the data storage simulation device. According to one approach, operation 312 may include collecting: temperature information from one or more temperature sensors in the data storage simulation device, power information from one or more current sensors in the data storage simulation device, and movement information from one or more accelerometers in the data storage simulation device. However, sensor readings may be collected from different types of sensors depending on the approach and the type of verification testing being performed.

Proceeding to operation 314, the collected sensor readings are returned to node 301. It follows that in preferred approaches, node 301 at least receives: temperature information from one or more temperature sensors in the data storage simulation device, power information from one or more current sensors in the data storage simulation device, and movement information from one or more accelerometers in the data storage simulation device. However, depending on the number and/or types of components (e.g., sensors) that are included in a data storage simulation device inserted in a drive slot for verification testing, additional information (e.g., sensor readings) may be received at node 301 from node 302.

At node 301, operation 316 includes using the sensor readings received from the data storage simulation device at node 302 to determine how components included in the data storage simulation device are performing. The sensor readings are also used to determine the type of operating environment that is present inside the exterior shell (e.g., outermost surface) of the data storage simulation device. Preferred approaches may thereby use temperature information, power information, and movement information received from the data storage simulation device to determine whether performance of the data storage simulation device is inside a predetermined range (or equivalently, outside of the predetermined range).

In other words, the temperature information, power information, and/or movement information is used to determine whether the present configuration of the data storage simulation device is verified. Accordingly, operation 318 includes determining whether each of the sensor readings received from node 302 are in a respective predetermined range, where the predetermined ranges are used to indicate (e.g., quantify) whether the data storage simulation device and components therein are performing desirably and able to satisfy the present segment of verification testing.

In response to determining that one or more of the received sensor readings are not in their respective predetermined ranges, method 300 advances from operation 318 to operation 320. There, operation 320 includes indicating the first set of operating conditions that produced the received sensor readings has failed verification. In other words, the first amount of power drawn, and the first amount of thermal energy released at node 302 in response to the instructions and signals sent in operation 308 caused the data storage simulation device to perform undesirably. It can thereby be extrapolated that the number, type, configuration, etc. of components included in the data storage simulation device are rated to operate in environments having the same power and thermal characteristics.

The first set of operating conditions that produced the received sensor readings may be flagged and stored in a lookup table at a cloud location. In some approaches, the first set of operating conditions may be written to memory in the data storage simulation device, e.g., to maintain a list of unverified operating conditions. From operation 320, method 300 returns to operation 306 such that a next set of operating conditions in the verification testing procedure may be implemented in the data storage simulation device. It follows that a number of the operations in method 300 may be repeated any desired number of times to ensure that each operating condition of a verification testing procedure is implemented and evaluated. However, method 300 may end in response to a final operating condition of a verification testing procedure having been implemented and evaluated, e.g., as would be appreciated by one skilled in the art after reading the present description.

Returning now to operation 318, method 300 advances to operation 322 in response to determining that each of the received sensor readings are in their respective predetermined ranges. There, operation 322 includes indicating the first set of operating conditions that produced the received sensor readings has been verified. In other words, the first amount of power drawn, and the first amount of thermal energy released at node 302 in response to the instructions and signals sent in operation 308 caused the data storage simulation device to perform desirably. It can thereby be extrapolated that the number, type, configuration, etc. of components included in the data storage simulation device are rated to operate in environments having the same power and thermal characteristics.

As noted above, the first set of operating conditions that produced the received sensor readings may be flagged and stored in a lookup table at a cloud location. In some approaches, the first set of operating conditions may be written to memory in the data storage simulation device, e.g., to maintain a list of verified operating conditions to supplement another list of unverified operating conditions. From operation 322, method 300 also returns to operation 306 such that a next set of operating conditions in the verification testing procedure may be implemented in the data storage simulation device. Again, the operations in method 300 may be repeated any desired number of times to ensure that each operating condition of a verification testing procedure is implemented and evaluated.

It follows that in response to returning to operation 306, a second set of operating conditions to implement at the data storage simulation device may be determined. Advancing again to operation 308, a new set of one or more instructions are sent to node 302 that cause the second set of operating conditions from the verification testing procedure to be implemented. In some approaches, the second set of operating conditions specifies a second power draw and a second amount of thermal energy to be released. Additional signals may also be sent such that operations 310, 312, 314, 316, 318 and one of operations 320 and 322 may also be repeated for the second set of operating conditions.

It follows that approaches herein are desirably able to simulate different power loadings at power loads that can be dynamically configured to emulate different workloads of a drive device that would be installed in the enclosure slots. Approaches are able to simulate thermal equivalence by mimicking the thermal dissipation of a given drive, providing a valid analog for thermal dissipation, on the correct side of the enclosure case. Approaches are also configured to provide shock and vibration measurements which are used to understand the enclosure environmental conditions.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A computer-implemented method (CIM) comprising, in response to a data storage simulation device being inserted into a drive slot:
causing a power load in the data storage simulation device to draw a first amount of power and release a first amount of thermal energy;
receiving temperature information from one or more temperature sensors in the data storage simulation device;
receiving power information from one or more current sensors in the data storage simulation device;
receiving movement information from one or more accelerometers in the data storage simulation device; and
using the temperature information, the power information, and the movement information to determine whether performance of the data storage simulation device is inside a predetermined range.

2. The CIM of claim 1, wherein the first amount of power and the first amount of thermal energy are correlated with a particular segment of verification testing.

3. The CIM of claim 1, further comprising:
in response to determining that the performance of the data storage simulation device is inside the predetermined range, indicating the first amount of power and/or the first amount of thermal energy are verified.

4. The CIM of claim 3, further comprising:
causing the power load in the data storage simulation device to draw a second amount of power and release a second amount of thermal energy;
receiving updated temperature information from the one or more temperature sensors in the data storage simulation device;
receiving updated power information from the one or more current sensors in the data storage simulation device;
receiving updated movement information from the one or more accelerometers in the data storage simulation device; and
using the updated temperature information, the updated power information, and the updated movement information to determine whether performance of the data storage simulation device is inside the predetermined range.

5. The CIM of claim 1, further comprising:
in response to determining that the performance of the data storage simulation device is not inside the predetermined range, indicating the first amount of power and/or the first amount of thermal energy are not verified.

6. The CIM of claim 1, wherein the data storage simulation device has a connection interface with a form factor that approximates a connection interface at an exterior of a hard disk drive.

7. The CIM of claim 6, wherein the drive slot is configured to receive each of: the connection interface of the data storage simulation device, and the connection interface at the exterior of a hard disk drive.

8. The CIM of claim 1, wherein the causing of the power load to draw the first amount of power and release the first amount of thermal energy includes sending power, ground, and Inter-Integrated Circuit (I2C) signals from a host system to the data storage simulation device.

9. A computer program product (CPP), comprising:
a set of one or more computer-readable storage media; and
program instructions, collectively stored in the set of one or more storage media, for causing a processor set to perform the following computer operations in response to a data storage simulation device being inserted into a drive slot:
cause a power load in the data storage simulation device to draw a first amount of power and release a first amount of thermal energy;
receive temperature information from one or more temperature sensors in the data storage simulation device;
receive power information from one or more current sensors in the data storage simulation device;
receive movement information from one or more accelerometers in the data storage simulation device; and
use the temperature information, the power information, and the movement information to determine whether performance of the data storage simulation device is inside a predetermined range.

10. The CPP of claim 9, wherein the first amount of power and the first amount of thermal energy are correlated with a particular segment of verification testing.

11. The CPP of claim 9, wherein the program instructions are for causing the processor set to further perform the following computer operations:
in response to determining that the performance of the data storage simulation device is inside the predetermined range, indicate the first amount of power and/or the first amount of thermal energy are verified.

12. The CPP of claim 11, wherein the program instructions are for causing the processor set to further perform the following computer operations:
cause the power load in the data storage simulation device to draw a second amount of power and release a second amount of thermal energy;
receive updated temperature information from the one or more temperature sensors in the data storage simulation device;
receive updated power information from the one or more current sensors in the data storage simulation device;
receive updated movement information from the one or more accelerometers in the data storage simulation device; and
use the updated temperature information, the updated power information, and the updated movement information to determine whether performance of the data storage simulation device is inside the predetermined range.

13. The CPP of claim 9, wherein the program instructions are for causing the processor set to further perform the following computer operations:
in response to determining that the performance of the data storage simulation device is not inside the predetermined range, indicate the first amount of power and/or the first amount of thermal energy are not verified.

14. The CPP of claim 9, wherein the data storage simulation device has a connection interface with a form factor that approximates a connection interface at an exterior of a hard disk drive.

15. The CPP of claim 14, wherein the drive slot is configured to receive each of: the connection interface of the data storage simulation device, and the connection interface at the exterior of a hard disk drive.

16. The CPP of claim 9, wherein the causing of the power load to draw the first amount of power and release the first amount of thermal energy includes sending power, ground, and Inter-Integrated Circuit (I2C) signals from a host system to the data storage simulation device.

17. A computer system (CS), comprising:
a processor set;
a set of one or more computer-readable storage media;
program instructions, collectively stored in the set of one or more storage media, for causing the processor set to perform the following computer operations in response to a data storage simulation device being inserted into a drive slot:
cause a power load in the data storage simulation device to draw a first amount of power and release a first amount of thermal energy;
receive temperature information from one or more temperature sensors in the data storage simulation device;
receive power information from one or more current sensors in the data storage simulation device;
receive movement information from one or more accelerometers in the data storage simulation device; and
use the temperature information, the power information, and the movement information to determine whether performance of the data storage simulation device is inside a predetermined range.

18. The CS of claim 17, wherein the program instructions are for causing the processor set to further perform the following computer operations:
in response to determining that the performance of the data storage simulation device is inside the predetermined range, indicate the first amount of power and/or the first amount of thermal energy are verified.

19. The CS of claim 17, wherein the program instructions are for causing the processor set to further perform the following computer operations:
in response to determining that the performance of the data storage simulation device is not inside the predetermined range, indicate the first amount of power and/or the first amount of thermal energy are not verified.

20. The CS of claim 17, wherein the causing of the power load to draw the first amount of power and release the first amount of thermal energy includes sending power, ground, and Inter-Integrated Circuit (I2C) signals from a host system to the data storage simulation device.
